(19) United States
(12) Patent Application Publication
(10) Pub. No.: US 2025/0182391 A1
(43) Pub. Date: Jun. 5, 2025

(54) SYSTEMS AND METHODS FOR MONITORING AND DETECTION OF CHANGES IN A FACILITY

(71) Applicant: Cameron International Corporation, Houston, TX (US)

(72) Inventors: Ali Rezaei, Houston, TX (US); Nasser Ghorbani, Houston, TX (US); Kishore Mulchandani, Menlo Park, CA (US)

(21) Appl. No.: 18/964,891

(22) Filed: Dec. 2, 2024

Related U.S. Application Data
(60) Provisional application No. 63/604,986, filed on Dec. 1, 2023.

(51) Int. Cl. G06T 17/00; G01S 17/89; G06V 10/764; G06V 20/40; G06V 20/52

(52) U.S. Cl. CPC G06T 17/00; G01S 17/89; G06V 10/764; G06V 20/44; G06V 20/52

(57) ABSTRACT

A system includes one or more sensors to obtain three-dimensional (3D) data in a facility and a processor communicatively coupled to the one or more sensors. The processor is configured to execute instruction to generate a 3D model of the facility based on a first 3D data received from the one or more sensors at a first time and receive a second 3D data from the one or more sensors at a second time after the first time. The processor is further configured to execute instructions to determine an event based on the second 3D data and the 3D model and output a notification via an electronic device based on the event.

### CROSS-REFERENCE TO RELATED APPLICATION

The present application is a U.S. Non-Provisional Patent Application claiming benefit of U.S. Provisional Patent Application No. 63/604,986, entitled “LIDAR-BASED ANOMALY DETECTION USING UNMANNED AUTONOMOUS VEHICLES”, filed Dec. 1, 2023, which is herein incorporated by reference.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Monitoring and detection systems are used throughout various industries to oversee events within a monitored area, such as the movement of people or things. Monitoring and detection systems may improve facility safety and/or improve manufacturing efficiency by enabling quick responses to detected events. Unmanned autonomous vehicles (e.g., UAVs), such as unmanned aerial vehicles, may be used in monitoring and detection systems to increase monitoring and detection capabilities. Specifically, unmanned autonomous vehicles may expand a monitoring area and may strengthen monitoring resolution, increasing detection capabilities and reducing false positives. Traditional monitoring and detection systems may utilize sensors or detection components with limited capabilities, such as cameras, increasing costs and decreasing monitoring capabilities.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system includes one or more sensors to obtain three-dimensional (3D) data in a facility and a processor communicatively coupled to the one or more sensors. The processor is configured to execute instruction to generate a 3D model of the facility based on a first 3D data received from the one or more sensors at a first time and receive a second 3D data from the one or more sensors at a second time after the first time. The processor is further configured to execute instructions to determine an event based on the second 3D data and the 3D model and output a notification via an electronic device based on the event.

In another embodiment, a method includes receiving three-dimensional (3D) data from one or more sensors in a facility, generating a 3D model of the facility based on a first 3D data received from the one or more sensors at a first time, receiving a second 3D data from the one or more sensors at a second time after the first time, determining an event based on the second 3D data and the 3D model, and outputting a notification via an electronic device based on the event.

In a further embodiment, a tangible and non-transitory machine readable medium comprising instructions to cause a processing system to receive three-dimensional (3D) data from one or more sensors in a facility, generate a 3D model of the facility based on a first 3D data received from the one or more sensors at a first time, receive a second 3D data from the one or more sensors at a second time after the first time, determine an event based on the second 3D data and the 3D model, and output a notification via an electronic device based on the event.

### BRIEF DESCRIPTION OF THE DRAWINGS

Various aspects of this disclosure may be better understood upon reading the following detailed description and upon reference to the drawings in which:

FIG. 1 is a schematic illustration of an embodiment of a monitoring and detection system, in accordance with an aspect of the present disclosure;

FIG. 2 is a schematic illustration of an embodiment of the monitoring and detection system, in accordance with an aspect of the present disclosure;

FIG. 3 is an aerial perspective view of an embodiment of a facility including the monitoring and detection system, in accordance with an aspect of the present disclosure;

FIG. 4 is a schematic diagram of an embodiment of a portion of the facility including the monitoring and detection system, in accordance with an aspect of the present disclosure; and

FIG. 5 is a flow diagram for an embodiment of a method related to the monitoring and detection system, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a control system (i.c., solely by the control system, without human intervention).

Within many industries, such as the oil and gas industry, a monitoring and detection system may include one or more sensors configured to detect one or more objects (e.g., three-dimensional objects) and/or events within a facility to enable informed decision making and/or automated processes. For example, sensors may be configured to detect humans (e.g., movement, location, and/or status such as medical status, authorization status, etc.), substances (e.g., compositions, locations, concentrations, etc.), mechanical components (e.g., locations, orientations, operating status, etc.), and so forth. In many instances, object monitoring may enable increased safety within the facility by providing notifications, warnings, or automated mitigation actions, depending on a detected event. Monitoring and detection systems may include certain optical sensors, such as surveillance cameras, to monitor and detect objects and events within the facility. Unfortunately, cameras are prone to specific drawbacks that may subject the monitoring and detection system to certain inefficiencies, rendering camera use ineffective in certain situations. For example, cameras typically receive data that is indicative of an image in two-dimensional (2D) space, preventing object and event recognition in three-dimensional (3D) space or with geographical identification (e.g., geotagging). Further, physical barriers within the facility may prevent line-of-site detection using cameras and camera placements. For example, in monitoring and detection systems, cameras may be static or fixed to walls or other structures of the facility, constricting the camera's monitoring area.

In accordance with one or more embodiments of this disclosure, a monitoring and detection system may be used to track objects and/or events (e.g., anomalies) within an area, such as a facility for oil and gas processing, using one or more light detection sensors. An object may be any three-dimensional object, including but not limited to a human, an animal, a mechanical component (e.g., valve, meter, tank, etc.), an electrical component (e.g., wire), a vehicle (e.g., car, truck) and so forth. An event may be an action related to the object, including, but not limited to, the movement of the object within the area, the addition or elimination of the object within the area, and/or a change in a location or orientation of the object within the area. For example, an event may be the movement or trespass of a human into a restricted area of the facility, such as a hazardous area of the facility. As another example, an event may be the detection of a dropped or forgotten object within the area, such as a dropped tool or mobile device. Additionally or alternatively, an event may be the detection of a change in the connection of an electrical wire within the facility. In certain embodiments, an event may be any positional change associated with equipment in the facility, including changes in positions of the equipment, changes in operating parameters or actuators that control the equipment, or any combination thereof. One example of an event is a changed position of a valve actuator that the controls the position of a valve between open and closed positions.

In order to accurately monitor and detect objects or events within the area, the monitoring and detection system may use one or more static and/or dynamic sensors to detect objects in 3D space. For example, the sensors may be light detection and ranging (LiDAR) sensors configured to provide and receive lasers to detect the object in 3D space to determine a location, shape, size, and trajectory of the object in real-time. For example, the LiDAR sensors may determine a distance of the object from the LiDAR sensor by targeting the object with a laser and measuring the time for the reflected laser to return to a receiver of the LiDAR sensor. The LiDAR sensor may be configured to scan or detect one or more of points (e.g., laser points, 3D data) in 3D space to define a 3D model or a point cloud. The point cloud is a collection or aggregation of points describing or defining a 3D object within the 3D space. Each point may be defined by three coordinates: x, y, and z, providing the point a location in 3D space. More attributes, such as i for intensity or RGB values for the red (r), green (g), and blue (b) color channels, may be added to the point clouds to increase the information associate with the 3D object. The LiDAR sensor may be configured to transmit or communicate the detected points to a controller (e.g., a processor-based controller or computer) as 3D data, where data-based models within the controller may generate one or more 3D models using the 3D data.

The controller may further include one or more algorithms and/or artificial intelligence (AI) configured to classify 3D objects and/or areas within the 3D models to enable informed decision making and/or automated processes. Further, the controller may include one or more additional algorithms and/or additional AI configured to monitor the 3D objects within the 3D models and detect changes in the positioning or orientation of the 3D objects. Additionally or alternatively, the controller may include one or more additional algorithms and/or additional AI configured to detect additional 3D objects within the 3D space.

To increase the accuracy or resolution of the 3D models, unmanned autonomous vehicles (UAVs), such as such as unmanned ground vehicles (UGVs) or ground-based drones, unmanned aerial vehicles or aerial drones, unmanned underwater vehicles (UUVs) or underwater drones, unmanned surface vehicles (USV) or uncrewed boats, and so forth, may be equipped with detection capabilities. For example, the UAVs may include one or more dynamic LiDAR sensors in addition or alternative to fixed or static LiDAR sensors within the monitoring and detection system. By using UAVs, monitoring in areas inaccessible or hidden from the static sensors may be accomplished, increasing detection capabilities.

Although the discussion herein is generally directed to oil and gas facilities, it may be advantageous to apply the disclosed techniques to other facilities or areas. For example, the techniques discussed herein may be applied in residential (e.g., houses) areas, commercial (e.g., stores, banks, warehouses) areas, or other industrial facilities or areas.

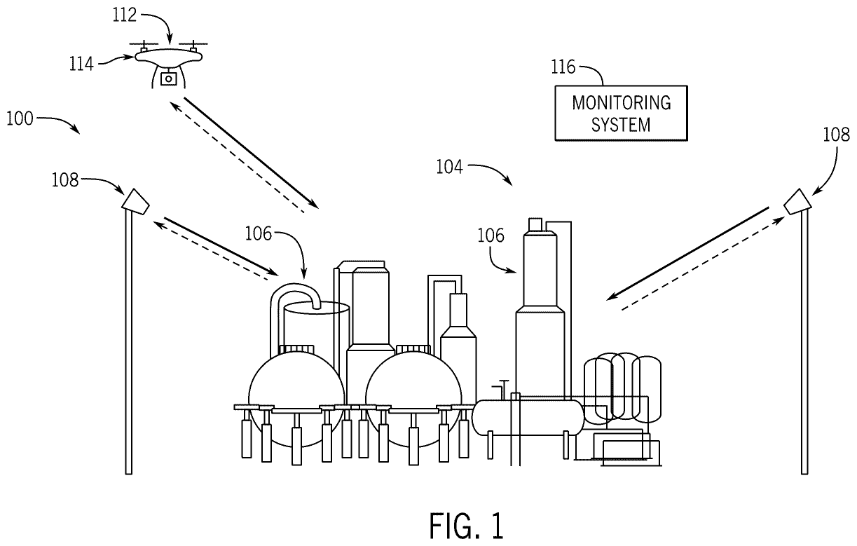

Turning now to the drawings, FIG. 1 illustrates an embodiment of a monitoring and detection system 100 configured to monitor a facility 104 to detect events associated with objects 106 of the facility 104. An object 106 may be any three-dimensional object, including, but not limited to, a human, an animal, a mechanical component (e.g., valve, pump, compressor, meter, pressure vessel, tank, reactor, building, etc.), an electrical component (e.g., wire, transformer, electric motor, actuator, etc.), a vehicle (e.g., car, a truck, a motorcycle, an aircraft, a watercraft, etc.) and so forth. In certain embodiments, the facility 104 may include a hydrocarbon (e.g., oil and gas) refinery, a hydrocarbon drilling facility, a hydrocarbon production facility, a manufacturing facility, a high security facility, or a combination thereof. Accordingly, the object 106 may include refinery equipment, drilling equipment, production equipment, manufacturing equipment, and high security equipment. In the illustrated embodiment, the object 106 may be a piping, a tank, a distillation tower, or another process component of the facility 104. An event may be an action related to the object 106, including but not limited to the movement of the object 106 within the facility 104, the addition of an object within the area, and/or a change in a location or orientation of the object 106 within the facility 104. For example, an event may be the movement or trespass of a human into a restricted area of the facility 104, such as a hazardous area of the facility 104.

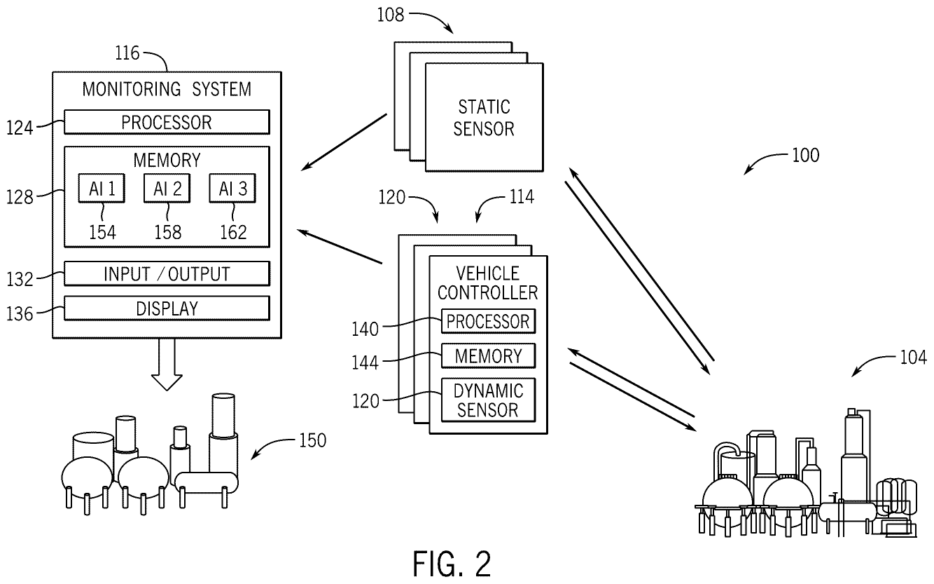

The monitoring and detection system 100 may include one or more static sensors 108 (e.g., fixed position sensors) and one or more dynamic sensors 112 (e.g., movable position sensors) configured to receive data indicative of a three-dimensional (3D) object, such as objects 106, within the facility 104. For example, the static and/or dynamic sensors 108, 112 may be light detection and ranging (LiDAR) sensors configured to detect objects in facility 104 to determine a location, a shape, a size, and/or a trajectory of the objects in real-time. For example, the static and/or dynamic sensors 108, 112 may determine a distance of the objects 106 from the static and/or dynamic sensors 108, 112 by targeting the objects 106 with a laser and measuring the time for the reflected laser to return to the static and/or dynamic sensor 108, 112. The direction of a laser and the measured time to receive the reflected laser may be indicative of a point in the facility 104 in 3D space. The static and/or dynamic sensors 108, 112 may be configured to transmit or communicate the detected points to a controller or a monitoring system 116 as 3D data (e.g., 3D LiDAR data), where data-based computer models within the controller may generate one or more 3D computer models (e.g., 3D model 150 illustrated in FIG. 2, point clouds) of the facility 104 using the 3D data. That is, the 3D models of the facility 104 may be generated as a collection or aggregation of points describing or defining objects (e.g., objects 106) of the facility 104. As will be appreciated, generation of the 3D models may be an iterative process, and a 3D model may be continually updated in real time based on updated 3D data from the static and/or dynamic sensors 108, 112. In other embodiments, generation of an updated or new 3D model may continually replace an older 3D model as updated 3D data is received.

The static sensors 108 may be fixed around or within the facility 104 and configured to monitor and detect objects and events. For example, static sensors 108 may be fixed or positioned on one or more walls within the facility 104 to monitor and interior of the facility 104 and/or may be positioned around the facility 104 (e.g., a perimeter of the facility 104) in order to monitor an exterior of the facility 104.

The dynamic sensors 112 may be configured to move within or outside of the facility 104 to provide precise sensing (e.g., high resolution sensing). As discussed briefly above, the dynamic sensors 112 may be coupled to unmanned autonomous vehicles (UAVs), such as an unmanned ground vehicle or an unmanned aerial vehicle, in order to provide transportability to the dynamic sensors 112. For example, a UAV 114, including a dynamic sensor 112, may move (e.g., drive, fly, etc.) through or around the facility 104 to transport the dynamic sensor 112 to various positions, such as near objects 106. In this way, high resolution monitoring may be achieved through proximity of the dynamic sensors 112 to the objects and/or events. Further, dynamic sensors 112 enable flexibility in monitoring areas of the facility 104. For example, in many facilities, static sensors 108 may have limited monitoring capabilities due to structural impairments, reducing the static sensor's 108 field of vision. In other instances, monitoring may be inhibited because of a dangerous or hazardous area, such as areas with high-pressure-high temperature (HPHT), potential hazardous gas (e.g., SO₂) concentration, and high noise areas. Dynamic sensors 112, such as a dynamic sensor 112 coupled to UAV 114, may enable monitoring and detection in inaccessible and/or hazardous areas, increasing monitoring and detection capabilities.

FIG. 2 is a schematic diagram of an embodiment of the monitoring and detection system 100 that includes the monitoring system 116 communicatively coupled to the static sensors 108 and the dynamic sensors 112. For example, the monitoring and detection system 100 includes one or more UAVs 114 having vehicle controllers 120 and dynamic sensors 112. As illustrated, the monitoring system 116 includes a processor 124 configured to execute instructions stored in memory 128. The memory 128 may be any suitable article of manufacture that can store the instructions. In some embodiments, the memory 128 is a tangible, non-transitory, machine-readable-medium that may store machine-readable instructions for execution by the processor 124. The memory 128 may include ROM, flash memory, a hard drive, or any other suitable optical, magnetic, or solid-state storage medium, or a combination thereof. The memory 128 may store data, instructions, and any other suitable information supporting operation of monitoring system 116. Additionally, the monitoring system 116 may include an input/output (I/O) port 132, which may include interfaces coupled to various components such as input devices (e.g., keyboard, mouse), input/output (I/O) modules, sensors (e.g., static sensors 108, dynamic sensors 112), and the like. Additionally, the monitoring system 116 includes a display 136 (e.g., an electronic display) having a graphical user interface (GUI) that may provide a visualization of measured feedback from sensors (e.g., static sensors 108 and dynamic sensors 112), alerts/alarms, monitoring reports, user-selectable control options, and a map of the facility with sensor locations to an operator of the facility 104.

As illustrated, the vehicle controller 120 of each UAV 114 may include generally similar features as the monitoring system 116. For example, the vehicle controller 120 includes a processor 140 configured to execute instructions stored in memory 144. The memory 144 may be any suitable article of manufacture that can store the instructions. In some embodiments, the memory 144 is a tangible, non-transitory, machine-readable-medium that may store machine-readable instructions for execution by the processor 140. The memory 144 may include ROM, flash memory, a hard drive, or any other suitable optical, magnetic, or solid-state storage medium, or a combination thereof. The memory 144 may store data, instructions, and any other suitable information supporting operation of the UAV 114 via the vehicle controller 120.

Additionally, the vehicle controller 120 may include or be coupled to one or more dynamic sensors 112. As discussed above, the dynamic sensors 112 may include a LiDAR sensor. In some embodiments, the dynamic sensor 112 includes a LiDAR sensor with a single photon detector. In some embodiments, the LiDAR sensor may be directional (e.g., emits laser(s) in generally one direction) while in other embodiments, the LiDAR sensor may include omnidirectional sensing or 360 degree detection. In any case, the dynamic sensor 112 may be lightweight (e.g., less than 10% of the weight of the UAV 114, less than 5% of the weight of the UAV 114, less than 2% of the weight of the UAV 114) and with low power consumption (e.g., less than 30 Watts (W), less than 20 W, or less than 10 W), which makes it amenable to UAV 114 deployment, for example.

The monitoring system 116 (e.g., the input/output), may be configured to receive a signal indicative of 3D data or points from the static sensors 108 and/or dynamic sensors 112. For example, the static and/or dynamic sensors 108, 112 may detect one or more points that may define one or more objects (e.g., objects 106) within the facility 104. As mentioned above, objects may be structural components (e.g., walls, beams, entries, etc.), equipment (e.g., heavy machinery, tanks, tool), people, animals, and/or other 3D objects within the facility 104. The static and/or dynamic sensors 108, 112 may transmit (e.g., via a signal) 3D data indicative of the one or more points to the monitoring system 116 to generate the one or more 3D models 150 of the facility 104 based on the transmitted 3D data. For example, each sensor of the static and/or dynamic sensors 108, 112 may detect a portion of the facility 104. A first static sensor 108 may detect and transmit 3D data to the monitoring system 116 indicative of a first portion of the facility 104. For example, the first static sensor 108 may be positioned at a first corner of the facility 104. A second, third and fourth static sensor 108 may detect and transmit 3D data to the monitoring system 116 indicative of second, third, and fourth portions of the facility 104. For example, the second, third, and fourth static sensors 108 may be positioned at a second, third, and fourth corner of the facility 104. The processor 124 of the monitoring system 116 may be configured to generate the 3D models 150 of the facility 104 based on the detected 3D data indicative of the first, second, third, and fourth portions of the facility 104, for example, by fusing (e.g., via algorithms or artificial intelligence) the respective 3D data into a single model. As will be appreciated the monitoring and detection system 100 is not limited to four sensors monitoring four portions of the facility 104, and a greater or fewer number of static and/or dynamic sensors 108, 112 may be utilized to monitor a greater of fewer number of portions of the facility 104. For example, static sensors 108 may be positioned around the facility 104 at any desirable interval and/or within the facility 104 at any desirable interval to increase the monitoring area.

In accordance with one or more embodiments of the present disclosure, dynamic sensors 112 may be used within the monitoring and detection system 100 to increase monitoring and detection capabilities. For example, the dynamic sensors 112 may enable increased resolution (e.g., image quality, detail, clarity) of the 3D models, increasing monitoring and detection capabilities. As discussed above, the dynamic sensors 112 may be coupled to one or more UAVs 114, configured to move through or around the facility 104 to monitor and detect objects and/or events. For example, the UAVs 114 may perform a random or sequenced movement plan (e.g., flight plan, drive plan) configured to position the dynamic sensors 112 proximate to objects (e.g., objects 106) within the facility 104. By positioning the UAVs 114, and the dynamic sensors 112, close to objects within the facility 104, the monitoring and detection system 100 may detect objects and events with increased precision or resolution. To further clarify, due to the proximity of the dynamic sensors 112 to an object or area to be detected, the dynamic sensors 112 may transmit (e.g., via a signal) 3D data to the monitoring system 116 to generate a 3D model with increased resolution, compared to a 3D model generated using static sensors 108 alone. Further, UAVs 114 and the coupled dynamic sensors 112 may enable monitoring and detection in areas blocked or obstructed from monitoring view of the static sensors 108 positioned in traditional locations. For example, UAVs 114 may be configured to fly or drive between equipment, into tight spaces, or in areas otherwise not monitored by static sensors 108. In this way, the 3D model generated by the monitoring system 116 may be more detailed or comprehensive, and monitoring and detection may be performed in hard-to-reach or inaccessible areas.

In embodiments, the monitoring system 116 may be configured “tag” (e.g., geotag) or add geographical or geospatial identification to the 3D models 150 or objects of the 3D models 150. For example, the 3D data from the static and/or dynamic sensors 108, 112 may include information indicative of the points in 3D space (e.g., x, y, z). Once received via monitoring system 116, algorithms and/or software within the memory 128 may be performed or executed by the processor 124 to determine the detected points of the 3D data in reality (e.g., the actual location is in the world). As will be appreciated, geotagging may be performed before, during, or after the 3D models 150 are generated by the processor 124. In any case, once geotagged, the 3D models 150 may represent the actual location of objects and events within the facility 104 in real time enabling informed decision making and/or improved autonomous actions by the UAVs 114 and/or a control system (e.g., processor-based controller) of the facility 104.

As discussed briefly above, the monitoring system 116 may be configured to classify one or more objects and/or areas within the 3D models 150. For example, the monitoring system 116 may classify certain objects within the 3D model 150, such as machinery or equipment, as hazardous or dangerous machinery or equipment within the facility 104. Further, the monitoring system 116 may classify certain areas within the 3D models 150 as hazardous or dangerous areas within the facility 104. To this end, the memory 128 of the monitoring system 116 may include artificial intelligence (AI) configured to determine and classify objects and/or areas within the 3D models 150 to enhance monitoring and detection capabilities. For example, a first AI model 154 may be configured to implement machine learning, such as convolutional neural network (CNN) techniques. When enabled in the monitoring system 116, the first AI model 154 may analyze input (e.g., source) data (e.g., 3D data, 3D models 150) to determine or classify objects and/or areas within the 3D models 150. For example, upon generating the 3D model 150s, the first AI model 154 of the monitoring system 116 may classify equipment (e.g., tanks, pumps, compressors, valves, separators, combustion engines, electric motors, machines, vehicles, tools, electronic components, etc.), structural components (e.g., walls, beams, doorways), humans, and/or areas within the 3D models 150. In some embodiments, the first AI model 154 may determine areas that may be hazardous or dangerous to human life, such as areas with high-pressure-high temperature (HPHT), potential hazardous gas (e.g., SO₂) concentration, and high noise areas. In some embodiments, the first AI model 154 may determine areas that require authorization within the facility 104. For example, a data storeroom or a control room of the facility 104 may be classified as a restricted area by the first AI model 154. In some embodiments, the classified areas may be determined at least partially based on a time of day. For example, during non-working times, the entire facility 104 may be classified by the first AI model 154 as a restricted zone. Conversely, during working times, only portions of the facility 104 may be classified by the first AI model 154 as a restricted zone. In some embodiments, the classified areas may be determined at least partially based on an operating mode within the facility 104 or an area of the facility 104. For example, a truck loading zone may be classified by the first AI model 154 as a hazardous area during times where truck loading occurs or traditionally occurs. Likewise, an area proximate to a high pressure, high temperature reactor may be classified by the first AI model 154 as a hazardous area during times of operation of the reactor, and not classified as a hazardous zone during suspension of the reactor.

To facilitate identifying and classifying objects and/or areas within the facility 104, the first AI model 154 may be trained to determine and implement machine learning parameters. For example, when the first AI model 154 implements convolutional neural network (CNN) techniques, the machine learning parameters may indicate number of convolution layers, inter-connections between layers, and/or convolution weights (e.g., coefficients) corresponding to each convolution layer. In some embodiments, the first AI model 154 may be trained by recursively adjusting the machine learning parameters based at least in part on expected objects or areas identified by processing (e.g., analyzing) training data, for example, with known object data (e.g., pictures or 3D models of equipment, humans, etc.).

In some embodiments, the 3D model 150 may be presented to an operator of the monitoring and detection system 100 to enable informed decision making. For example, the monitoring system 116 may be configured to render or display the 3D models 150 and updated 3D models onto the display 136 for visualization by the operator. In certain embodiments, the 3D model 150 may be used by the UAVs 114 to initiate additional monitoring (e.g., additional measurements) in the facility 104 and/or by the control system (e.g., processor-based controller) to adjust operating parameters of various equipment at the facility 104 (e.g., valve position, speed of pump or compressor, fuel injection in a combustion engine, inputs to a reactor, and so forth).

As discussed above, the monitoring and detection system 100 may be configured to continuously monitor the facility 104 to detect events associated with the one or more objects or areas of the facility 104. For example, the monitoring system 116 may be configured to receive, from the static and/or dynamic sensors 108, 112, updated 3D data to generate updated or additional 3D models of the facility 104, based on the updated 3D data. That is, the monitoring system 116 may be configured to continuously receive 3D data from static and/or dynamic sensors 108, 112 to continuously generate updated 3D models of the facility 104 in real time. In this way, the monitoring and detection system 100 may be configured to detect events, such as the movement of objects or people within the facility 104 in real time. By way of example, upon generating an updated 3D model of the facility 104, the monitoring system 116 may be configured to determine events, such as the movement of humans or objects, based on a comparison between the 3D models 150 (e.g., first, initial, previous, original 3D models) of the facility 104 and the updated 3D models (e.g., second, updated, additional, subsequent 3D models) of the facility 104.

For example, the monitoring system 116 may be configured to generate a first 3D model of the facility 104 based on 3D data received from the static and/or dynamic sensors 108, 112 at a first time. At a second time, after the first time, the monitoring system 116 may generate a second 3D model of the facility 104 based on updated or second 3D data received from the static and/or dynamic sensors 112. The monitoring system 116 may be configured to compare the first 3D model to the second 3D model to determine differences between the models. For example, a difference may be addition to the first 3D model (e.g., addition of objects or points defining objects), a removal from the first 3D model (e.g., elimination of objects or points defining objects), and/or a change in the first 3D model (e.g., change in the location or orientation of objects or points defining objects).

Based on the difference of the first and second 3D models, the monitoring system 116 may be configured to determine an event. For example, the monitoring system 116 may determine a person or object entering a hazardous or restricted area of the facility 104 based on the comparison between the first and second 3D models. By further example, the monitoring system 116 may determine a change in various equipment (e.g., valve, pump, compressor, separator, reactor, etc.) based on the comparison between the first and second 3D models. The change in various equipment may include a physical change in an actuator, such as a manual actuator (e.g., a handwheel, lever, or knob), that operates the equipment (e.g., valve). The change in various equipment may also include a positional change due to unauthorized tampering with the equipment, operational changes (e.g., vibration) causing movement of the equipment, weather (e.g., wind, flood, earthquake, etc.) causing movement of the equipment, or any combination thereof.

To this end, the memory 128 of the monitoring system 116 may include a second AI model 158 that may be configured to implement machine learning, such as convolutional neural network (CNN) techniques. When enabled in the monitoring system 116, the second AI model 158 may analyze input (e.g., source) data (e.g., 3D data, 3D models 150, updated 3D models) to determine events. For example, upon generating the 3D models 150 and updated 3D models, the second AI model 158 of the monitoring system 116 may determine an event based on one or more differences between the 3D models 150 and the updated 3D models of the facility 104. In some embodiments, the second AI model 158 may determine when a human is entering a restricted or hazardous area. For example, the upon classifying restricted or hazardous areas within 3D models (e.g., 3D models 150, updated 3D models) by the first AI model 154, the second AI model 158 may be configured to determine when the human enters a restricted or hazardous area in real time. In other embodiments, the second AI model 158 may determine when a human is leaving a classified area. For example, the upon classifying areas within 3D models (e.g., 3D models 150, updated 3D models) by the first AI model 154, the second AI model 158 may be configured to determine when a human leaves an area, such as an area requiring constant human supervision over machinery. In some embodiments, the second AI model 158 may determine a speed or trajectory of an object, such as a car or a human. For example, the second AI model 158 may be configured to determine a speed of a car within a classified area of the facility 104 (e.g., a parking lot of the facility 104) to further determine whether the car is traveling at speeds faster than allowable within the facility 104.

To facilitate identifying events, the second AI model 158 may be trained to determine and implement machine learning parameters. For example, when the second AI model 158 implements convolutional neural network (CNN) techniques, the machine learning parameters may indicate number of convolution layers, inter-connections between layers, and/or convolution weights (e.g., coefficients) corresponding to each convolution layer. In some embodiments, the second AI model 158 may be trained by recursively adjusting the machine learning parameters based at least in part on expected objects or areas identified by processing (e.g., analyzing) training data, for example, with known object data (e.g., movement patterns of vehicles, movement patterns of people, etc.).

In addition to determining movements of objects or people relative to the facility 104, the monitoring system 116 may be configured to determine additions, removals, or changes to objects within the facility 104. That is, the monitoring system 116 may be configured to compare the 3D models 150, or the known locations and orientations of the objects defining the 3D models 150, to updated 3D models (e.g., the second 3D model) to determine changes in the locations and orientations of objects. For example, the monitoring system 116 may determine whether an object has been removed from the facility 104, has changed locations within the facility 104, or if new objects have appeared in the facility 104. To this end, the memory 128 of the monitoring system 116 may include a third AI model 162 that may be configured to implement machine learning, such as convolutional neural network (CNN) techniques. When enabled in the monitoring system 116, the third AI model 162 may analyze input (e.g., source) data (e.g., 3D data, 3D models 150, updated 3D models) to determine events. For example, upon generating the 3D models 150 and updated 3D models at a later time, the third AI model 162 of the monitoring system 116 may determine an event based on one or more differences between the 3D models 150 and the updated 3D models. In some embodiments, the third AI model 162 may determine when an object is missing from the facility 104 or a classified area of the facility 104. For example, the third AI model 162 may be configured to determine when job specific tools are missing or removed from a classified area (e.g., determined by first AI model 154), such as an area associated with the job specific tools. As another example, the third AI model 162 may be configured to determine when an object has changed location or orientation within the facility 104. For example, the third AI model 162 may be configured to determine that an electronic wire has been disconnected based on the 3D models 150 and the updated 3D models. Further, the third AI model 162 may be configured to determine when an object has been added to the facility 104. For example, the third AI model 162 may be configured to determine that new tool, such as a misplaced or dropped tool, has been added to the facility 104 based on the 3D models 150 and the updated 3D models.

To facilitate identifying events, the third AI model 162 may be trained to determine and implement machine learning parameters. For example, when the third AI model 162 implements convolutional neural network (CNN) techniques, the machine learning parameters may indicate number of convolution layers, inter-connections between layers, and/or convolution weights (e.g., coefficients) corresponding to each convolution layer. In some embodiments, the third AI model 162 may be trained by recursively adjusting the machine learning parameters based at least in part on expected objects or areas identified by processing (e.g., analyzing) training data, for example, with known object data (e.g., shapes, locations, and orientations of objects).

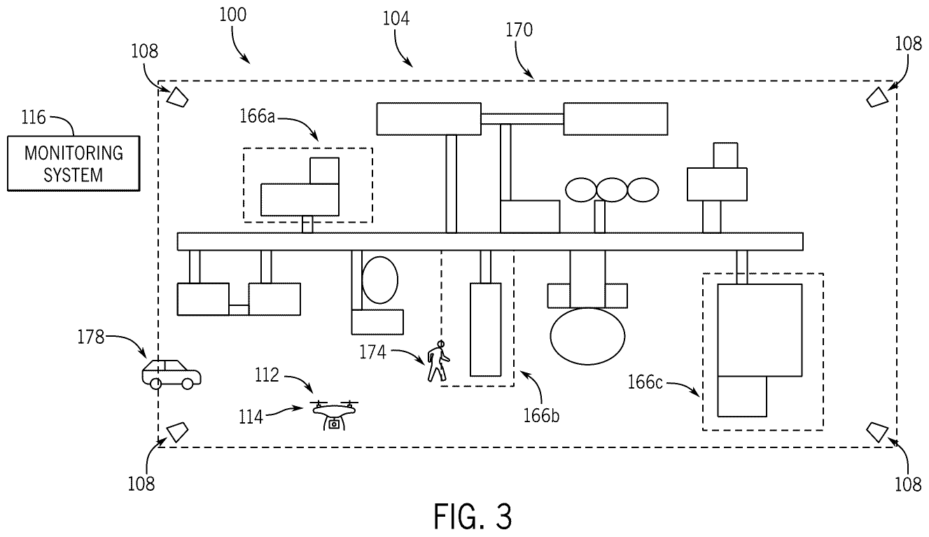

To further illustrate the embodiments of the present disclosure, FIG. 3 shows an aerial view of the facility 104 including an embodiment of the monitoring and detection system 100. As discussed above, the monitoring and detection system 100 may include the one or more static sensors 108 fixedly positioned around and/or within the facility 104 and the one or more dynamic sensors 112, such as dynamic sensors 112 coupled to one or more UAVs 114. The monitoring and detection system 100 may include the monitoring system 116 configured to receive 3D data (e.g., 3D LiDAR data) from the static and/or dynamic sensors 108, 112 to generate one or more 3D models (e.g., 3D model 150) of the facility 104. The monitoring system 116 may further include AI, such as the first AI model 154, configured to process the 3D models to determine or classify one or more objects and/or areas of the facility 104. In some embodiments, the first AI model 154 may additionally be configured to identify area specific rules associated with the classified areas, such as rules pertaining to trespass, dropped items, speed limits, capacity limits, and so forth. In the illustrated example, the monitoring system 116 (e.g., the first AI model 154) may identify and classify areas 166a, 166b, 166c within the 3D models, based on certain characteristics. For example, the monitoring system 116 may determine area 166a is a hazardous area due to the high temperature and high pressure equipment used therein. The monitoring system 116 may further determine area 166b is a restricted area because it includes propriety or confidential information, such as a data store room. The monitoring system 116 may further classify area 166c as a parking garage or a parking structure including speed limits for vehicles and other vehicle specific rules.

In some embodiments, monitoring system 116 may determine a perimeter of the areas 166a, 166b, 166c and/or a perimeter 170 of the facility 104 within the one or more 3D models. With the areas 166a, 166b, 166c and/or the perimeters classified within the one or more 3D models, the monitoring system 116 may further determine one or more events based on the areas 166a, 166b, 166c and/or rules associated with the areas 166a, 166b, 166c.

For instance, the monitoring system 116 may compare the one or more 3D models, such as a first 3D model and updated 3D model(s), to determine one or more events. For example, based on the comparison between the one or more 3D models, the monitoring system 116 may determine a human 174 is entering or has entered the restricted area 166b. That is, the monitoring system 116 may determine that a real-time location of the human 174 is within the restricted area, based on the one or more 3D models. As discussed above, the second AI model 158 may facilitate the determination that the human 174 has entered the restricted area 166b, as determined by the first AI model 154. In some embodiments, the monitoring system 116 may determine that the human 174 is within area 166b (e.g., the restricted area) during a certain time period. For example, the monitoring system 116 may classify area 166b as a restricted area during non-operating times of the facility 104 (e.g., at nighttime or a holiday).

In any case, upon a determination that an event has occurred or is occurring (e.g., a human has entered a classified area, such as area 166b), the monitoring system 116 may perform one or more subsequent actions in response to the event. For example, the monitoring system 116 may transmit or communicate a notification or warning to an operator of the facility 104 or the relevant authorities (e.g., police), based on the event. In some embodiments, the monitoring system 116 may actuate, adjust, and/or physical components within the facility 104 based on the event. For example, the monitoring system 116 may trigger or actuate a door to lock, a window to lock, equipment to lock or change, fire mitigation systems, chemical mitigation systems, and so forth. In some embodiments, the monitoring system 116 may perform or trigger one or more electrical responses based on the event. For example, the monitoring system 116 may transmit or communicate one or more signals to electrical devices (e.g., monitors, facility controls) within area 166b to lock based on the event. In some embodiments, the monitoring system 116 may transmit or communicate one or more signals to one or more UAVs 114 to position a dynamic sensor 112 proximate to the event (e.g., trespass) to perform additional monitoring and detection, increasing the resolution of the 3D models and the knowledge of the event.

In another embodiment, based on the comparison between the one or more 3D models, the monitoring system 116 may determine a vehicle 178 (e.g., car, truck, motorcycle, etc.) is moving (e.g., entering, exiting) relative to the facility 104. That is, the monitoring system 116 may determine that a real-time location of the vehicle 178 is within the perimeter 170 of the facility 104, based on the one or more 3D models. As discussed above, the second AI model 158 may facilitate the determination that the vehicle 178 has entered the perimeter 170, as determined by the first AI model 154. In some embodiments, the monitoring system 116 may determine that the vehicle 178 is within the perimeter 170 during an authorized time period (e.g., operating hours of the facility 104) or an unauthorized time period (e.g., nonoperating hours of the facility 104). In some embodiments, the monitoring system 116 may determine the number of vehicles and/or humans within the perimeter 170 of the facility 104 based on the one or more 3D models. In some instances, the monitoring system 116 may determine a speed and trajectory of the vehicle 178 based on the 3D models. For example, the monitoring system 116 may determine a speed of the vehicle 178 within the perimeter 170 to further determine whether the vehicle 178 is moving at speeds greater than a set limit (e.g. speed limit).

In any case, upon a determination that an event has occurred or is occurring (e.g., vehicle 178 entering perimeter 170, vehicle 178 speeding), the monitoring system 116 may perform one or more subsequent actions in response to the event. For example, the monitoring system 116 may transmit or communicate a notification or warning to the driver, an operator of the facility 104, and/or the relevant authorities (e.g., police), via one or more electronic devices (e.g., audio speaker, electronic display, etc.) based on the event. In some embodiments, the monitoring system 116 may actuate physical components within the facility 104 based on the event. For example, the monitoring system 116 may trigger or actuate a vehicle barrier, a gate, and so forth to mitigate consequences due to the event. In some embodiments, the monitoring system 116 may transmit or communicate one or more signals to one or more UAVs 114 including dynamic sensors 112 to position itself proximate to the event (e.g., vehicle 178 entering perimeter 170). In this way, the dynamic sensors 112 may perform additional, enhanced monitoring and detection to increase knowledge of the event.

It will be appreciated that responses to events determined by the monitoring system 116 are not limited to the above examples, and any suitable response to an event is within the embodiments of this disclosure. Other suitable responses include triggering alarms, dispatching UAVs configured to perform one or more additional sensing functions (e.g., gas sensing, audio sensing, temperature sensing etc.), dispatching UAVs configured to perform one or more tasks beyond monitoring and detection (e.g., cleaning, retrieving items, providing items), and so forth.

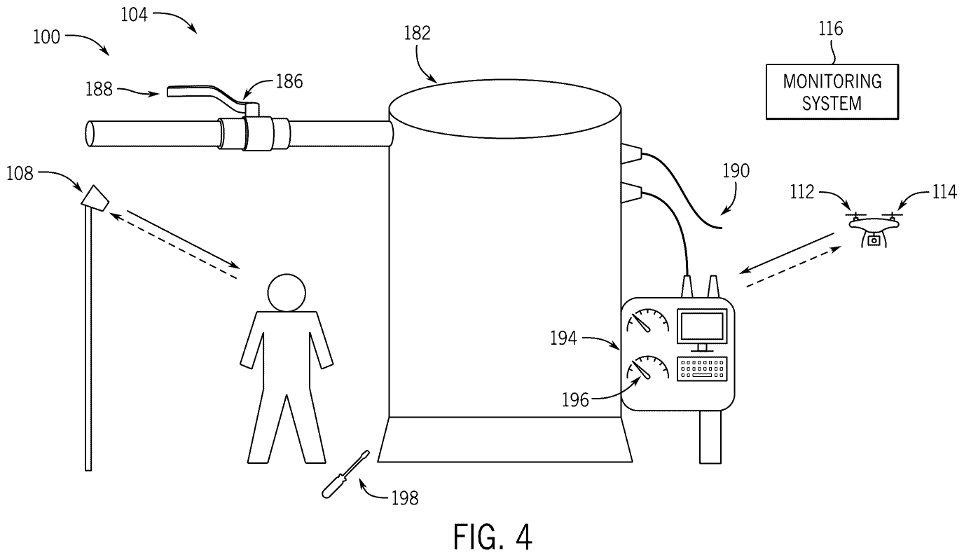

FIG. 4 shows schematic illustration of a portion the facility 104 including an embodiment of the monitoring and detection system 100, in accordance with the present disclosure. As discussed above, the monitoring and detection system 100 may include the one or more static sensors 108 fixedly positioned around and/or within the facility 104 and the one or more dynamic sensors 112, such as dynamic sensors 112 coupled to the UAV 114. The monitoring and detection system 100 may include the monitoring system 116 configured to receive 3D data from the static and/or dynamic sensors 108, 112 to generate one or more 3D models (e.g., 3D model 150) of the facility 104. The monitoring system 116 may further include AI, such as the first AI model 154, configured to process the one or more 3D models to determine or classify one or more objects and/or areas of the facility 104. For example, the monitoring system 116 may be configured to classify certain equipment, such as tank 182 within the facility 104. With the one or more objects (e.g., tank 182) classified, the monitoring system 116 may determine one or more events based on the classified one or more objects.

For instance, the monitoring system 116 may compare the 3D models, such as a first 3D model and updated 3D models, to determine one or more events. That is, based on the comparison between the 3D models, the monitoring system 116 may determine additions, removals, or changes to objects of the facility 104. As discussed above, the third AI model 162 may facilitate the determination that an object is removed, that an object has changed orientation or location, or if a new object appears within the facility 104. In an embodiment, the monitoring system 116 may identify changes in an orientation of an object (e.g., a valve, pump, compressor, electric motor, combustion engine, chemical reactor, meter, wire) and/or associated actuators within the facility 104. For example, the static and/or dynamic sensors 108, 112 may transmit 3D data to the monitoring system 116 to determine an initial or first location and orientation of a valve 186, such as an orientation of an associated valve actuator 188 (e.g., handwheel, lever, or knob), within the facility 104. The static and/or dynamic sensors 108, 112 may transmit updated 3D data to the monitoring system 116 to determine an updated or second location and orientation of the valve 186 (e.g., valve actuator 188). The monitoring system 116 may compare the first location and orientation to the second location and orientation of the valve 186 (e.g., valve actuator 188) to determine an event, such as an unplanned or unauthorized change to the valve 186 orientation (e.g., closed, open). In embodiments, the monitoring system 116 may also confirm a location and orientation of the valve 186 (e.g., valve actuator 188) via, for example, comparing a detected location and orientation of the valve 186 (e.g., valve actuator 188) to an expected location and orientation (for example, an expected location and orientation stored within the memory 128).

In another example, the static and/or dynamic sensors 108, 112 may transmit 3D data to the monitoring system 116 to determine an initial or first location and orientation of a wire 190, such as a connected or plugged orientation. The static and/or dynamic sensors 108, 112 may transmit updated 3D data to the monitoring system 116 to determine an updated or second location and orientation of the wire 190. The monitoring system 116 may compare the first location and orientation to the second location and orientation of the wire 190 to determine an event, such as an accidental disconnection of the wire 190. As will be appreciated, utilization of dynamic sensors 112 may enable generation of 3D models capable of defining small objects, such as wires.

In another embodiment, the static and/or dynamic sensors 108, 112 may transmit 3D data to the monitoring system 116 to determine an initial or first location and orientation of a meter 194 (e.g., gauge), such as location of a hand 196 of the meter 194 indicating a measurement of a parameter (e.g., pressure, temperature). The static and/or dynamic sensors 108, 112 may transmit updated 3D data to the monitoring system 116 to determine an updated or second location and orientation of the meter 194 (e.g., hand 196). The monitoring system 116 may compare the first location and orientation to the second location and orientation of the meter 194 (e.g., hand 196) to determine an event, such as hazardous increases in temperature and/or pressure detected by the meter 194.

In an embodiment, the monitoring system 116 may identify an addition of one or more objects within the facility 104. For example, the static and/or dynamic sensors 108, 112 may transmit 3D data to the monitoring system 116 to determine an initial or first 3D models. The static and/or dynamic sensors 108, 112 may transmit updated 3D data to the monitoring system 116 to determine updated 3D models of the facility 104. The monitoring system 116 may compare the first 3D models to the updated 3D models to determine an event, such a tool 198 being accidentally dropped onto the floor of the facility 104, or a mobile device being left at a station based on differences between the models.

Upon a determination that an event has occurred or is occurring (e.g., valve 186 has changed orientation, wire 190 disconnected, tool 198 dropped), the monitoring system 116 may perform one or more subsequent actions in response to the event. In an embodiment, the monitoring system 116 may transmit or communicate a notification or warning to an operator of the facility 104 via an electronic device (e.g., audio speaker, electronic display, etc.) based on the event. For example, the monitoring system 116 may transmit a notification to a nearby worker to the location of the event. In some embodiments, the monitoring system 116 may actuate physical components within the facility 104 based on the event. For example, the monitoring system 116 may automatically send a signal to the valve 186 (e.g., powered actuator) to actuate the valve to the correct orientation. The powered actuator may include an electric actuator, a fluid-driven actuator (e.g., hydraulic or pneumatic actuator), or a combination thereof. As another example, the monitoring system 116 may transmit a control signal to a controller of the equipment monitored by the meter 194, to alter an operating parameter of the equipment, based on the event. In some embodiments, the monitoring system 116 may transmit or communicate one or more signals to one or more UAVs 114 to move the UAVs 114 and its dynamic sensors 112 proximate to the event (e.g., proximate to the valve 186, wire 190, meter 194, tool 198).

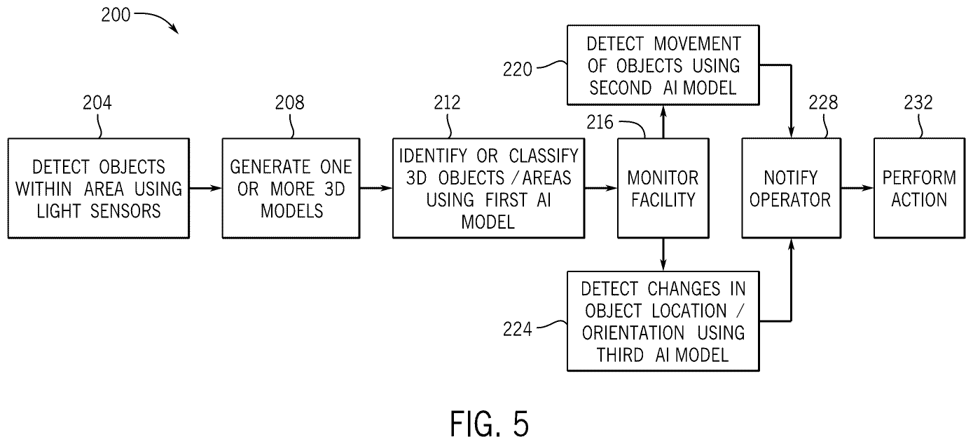

FIG. 5 illustrates a method 200 related to an embodiment of the monitoring and detection system 100, in accordance with one or more embodiments of this disclosure. It should be noted that the method 200 is not limiting, and the monitoring and detection system 100 and/or the method 200 may include additional or fewer steps than those illustrated. Further, the monitoring and detection system 100 and/or the method 200 may include steps that are performed in an alternative order to that illustrated method 200. That is, certain steps may be performed before, after, and/or concurrently to/with another respective step.

Referring now to block 204, the monitoring system 116 of the monitoring and detection system 100 may detect objects within an area, such as the facility 104. For example, the monitoring and detection system 100 may include the one or more static sensors 108 and/or the one or more dynamic sensors 112 configured to detect objects using, for example, LiDAR technology. As discussed before, the static sensors 108 may be fixedly positioned around the perimeter of the facility 104 and/or along structural components, such as walls, within the facility 104. Additionally or alternatively the one or more dynamic sensors 112 may be coupled to one or more UAVs 114, configured to increase monitoring and detection capabilities. The static and/or dynamic sensors 108, 112 may include light detection sensors, such as LiDAR sensors, configured to detect and transmit 3D data (e.g., points in 3D space) to the monitoring system 116.

At block 208, the monitoring system 116 of the monitoring and detection system 100 may generate one or more 3D models based on the 3D data received from the static and/or dynamic sensors 108, 112, detected in block 204. For example, the monitoring system 116 may aggregate or fuse 3D data from at least one sensor of the one or more static sensors 108 and at least one sensor of the one or more dynamic sensors 112 to generate one or more 3D models of the facility 104. In some embodiments, the monitoring system 116 may geotag the one or more 3D models to further increase detection and response capabilities. For example, the monitoring system 116 may identify the actual location of components or objects defining the one or more 3D models in reality, in real time. In certain embodiments, the 3D models may include 3D facility models of the facility 104 and 3D equipment models of individual equipment (e.g., valves, pumps, compressors, electric motors, combustion engines, pressure vessels, tanks, chemical reactors, etc.) and associated geotags. For example, one or more 3D valve models and associated geotags may identify 3D coordinates of the valves in the facility 104. By further example, one or more 3D pump models and associated geotags may identify 3D coordinates of the pumps in the facility 104.

At block 212 the monitoring system 116 of the monitoring and detection system 100 may identify or classify objects and/or areas within the facility 104. For example, the monitoring system 116 may include the first AI model 154 configured to classify objects and/or areas within the facility 104 based on the one or more 3D models. In embodiments, the first AI model 154 may be configured to determine certain components or machines within the facility 104. For example, based on the 3D models, the first AI model 154 may be configured to identify equipment (e.g., valves, pumps, compressors, electric motors, combustion engines, pressure vessels, tanks, chemical reactors, control panels, etc.) within the facility 104. In another embodiment, the first AI model 154 may be configured to classify hazardous and/or restricted areas of the facility 104 based on 3D models. For example, the first AI model 154 may be configured to identify and classify a high heat, high pressure area as a dangerous area not suitable for human workers.

At block 216, the monitoring system 116 of the monitoring and detection system 100 may be configured to continuously monitor the facility 104 in real time. For example, the monitoring system 116 may be configured to receive additional or updated 3D data from the static and/or dynamic sensors 108, 112. With the updated 3D data, the monitoring system 116 may be configured to generate one or more updated 3D models of the facility 104 in real time. The monitoring system 116 may compare the one or more 3D models (e.g., first 3D models) to the one or more updated 3D models of the facility 104 to determine events associated with objects within the facility 104.

For example, at block 220, the monitoring system 116 may detect movement of objects using the second AI model 158 based on the comparison of the 3D models and the updated 3D models. For example, the monitoring system 116 may determine a person or object entering a hazardous or restricted area of the facility 104 (e.g., determined by the first AI model 154) based on the comparison of the 3D models and the updated 3D models, as discussed in detail above.

At block 220, the monitoring system 116 may detect changes in object's locations or orientations using the third AI model 162 based the comparison of the 3D models and the updated 3D models. For example, the monitoring system 116 may determine an object within the facility 104 is missing or has changed locations or orientation, based on the comparison of the 3D models and the updated 3D models. Further, the monitoring system 116 may determine an object within the facility 104 is new or an addition, based on the comparison of the 3D models and the updated 3D models, as discussed in detail above. As will be appreciated, in embodiments, steps performed in block 220 and 224 may be performed simultaneously.

In any case, upon a detection of an event in either blocks 220 or 224, the monitoring system 116 may transmit or communicate a notification or warning to an operator of the facility 104 in block 228. For example, the monitoring system 116 may notify the operator of a dropped object within the facility, such as a tool, that may create a dangerous work environment. In some cases, the monitoring system 116 may trigger an alarm (e.g., lights, alarm sounds) based on the event. In an embodiment, the monitoring system 116 may present response options, via a graphical user interview on an electronic display, to the operator of the facility 104. For example, the response options may be triggering an alarm, performing some action (e.g., closing a valve, decreasing temperature of a reactor, etc.), and so forth.

Additionally or alternatively, the monitoring system 116 may perform one or more automatic actions at block 232. For example, the monitoring system 116 may transmit or communicate signals to components of the facility 104 to perform a physical action based on the event. In an embodiment, the monitoring system 116 may transmit a signal to a door of the facility 104 to open, close, lock, or unlock based on the event (e.g., trespasser, facility fire). In another embodiment, the monitoring system 116 may transmit a signal to one or more electrical components of the facility 104 based on the event. For example, the monitoring system 116 may lock one or more controls of a monitor or control panel in response to the event. In an embodiment, in response to a determination that a component (e.g., an actuator, valve, pump, etc.) has moved position and/or orientation, the monitoring system 116 may send a signal (e.g., actuation signal) to actuate the component to a correct or desired position. For example, upon determining an electronic valve has undesirably moved position and/or orientation, the monitoring system 116 may send a signal to the electronic valve to actuate the valve to a correct or desired position and orientation. In some embodiments, in response to a determination that a component (e.g., valve actuator 188), has moved position or orientation (e.g., due to vibrations) the monitoring system 116 may send a signal to adjust a parameter (e.g., speed, power, flow rate) of the associated equipment (e.g., compressors, reactor) to reduce vibrations. For example, in response to a determination that a position or orientation of a valve hand (e.g., valve actuator 188) has moved to an undesirable location or orientation, the monitoring system 116 may send a signal to a reactor to reduce a flow rate, thereby reducing vibrations. In some embodiments, in response to a determination that a component (e.g., hand 196) has moved to a position or orientation indicative of a critical, hazardous, or otherwise dangerous condition, the monitoring system 116 may send a signal to shutdown associated equipment. Other suitable responses include dispatching UAVs configured to perform one or more additional sensing functions (e.g., gas sensing, audio sensing, temperature sensing etc.) and dispatching UAVs configured to perform one or more tasks beyond monitoring and detection (e.g., cleaning, retrieving items, providing items, fire suppression), and so forth.

Technical effects of the disclosed embodiments include LiDAR measurements taken from various sensors (e.g., fixed and dynamic sensors) in a facility to monitor people, vehicles, and equipment. In particular, the LiDAR measurements can provide 3D data for modeling locations and movements of people, vehicles, and equipment in the facility. The LiDAR measurements may be more accurate than other measurement techniques, such as cameras, in a wide variety of environmental conditions, including varying light conditions (e.g., dark or light), rain, fog, and smoke. The LiDAR measurements may be used alone or in combination with other sensor measurements, such as measurements from wind sensors, temperature sensors, pressure sensors, humidity sensors, gas sensors, leak sensors, and imaging sensors (e.g., cameras). The LiDAR measurements may be used to track both known and unknown objects in the facility, including all of the known equipment in a 3D facility model and unknown/dynamic objects (e.g., people, vehicles, and equipment) that may come and go at the facility. The LiDAR measurements also may be used to monitor an operational status or control position of various equipment, such as by monitoring actuators (e., valve actuator, pump control, compressor control, etc.) and by monitoring gauges (e.g., hand of a pressure gauge, temperature gauge, or flow meter). In some embodiments, the LiDAR measurements may be used to monitor for accidents or damage at the facility, such as fallen parts, broken equipment, injured personnel, and so forth. Thus, based on the LiDAR measurements, a monitoring system and/or a control system may generate notifications (e.g., audible or visual notifications) on an electronic device (e.g., audio speaker and/or electronic display), trigger or initiate additional inspections by the sensors, control security measures at the facility (e.g., locking or unlocking doors, setting off alarms, closing or opening vehicle access gates, etc.), and control the equipment at the facility (e.g., adjusting valves, pumps, compressors, etc.).

The subject matter described in detail above may be defined by one or more clauses, as set forth below.

A system includes one or more sensors to obtain three-dimensional (3D) data in a facility and a processor communicatively coupled to the one or more sensors. The processor is configured to execute instruction to generate a 3D model of the facility based on a first 3D data received from the one or more sensors at a first time and receive a second 3D data from the one or more sensors at a second time after the first time. The processor is further configured to execute instructions to determine an event based on the second 3D data and the 3D model and output a notification via an electronic device based on the event.

The system of any preceding clause, comprising an unmanned autonomous vehicle (UAV) having a first sensor of the one or more sensors.

The system of any preceding clause, wherein the one or more sensors comprises a second sensor at a fixed position in the facility.

The system of any preceding clause, wherein the one or more sensors comprise a Light Detection and Ranging (LiDAR) sensor.

The system of any preceding clause, wherein the processor is configured to execute instructions to classify one or more objects or one or more areas within the 3D model.

The system of any preceding clause, wherein the one or more areas are one or more hazardous or restricted areas of the facility, and the event comprises a human entering the one or more hazardous or restricted areas.

The system of any preceding clause, wherein the processor is configured to execute instructions to classify the one or more objects or the one or more areas within the 3D model via an artificial intelligence model, and the artificial intelligence model is configured to implement machine learning to classify the one or more objects or the one or more areas within the 3D model.

The system of any preceding clause, wherein the processor is configured to execute instructions to send an actuation signal to at least one equipment of the facility based on the event.

The system of any preceding clause, wherein the processor is configured to determine the event based on the second 3D data via an artificial intelligence model configured to implement machine learning to determine the event.

The system of any preceding clause, wherein the event comprises a change in position of equipment, a change in an actuator position of the equipment, or a combination thereof, in the facility.

A method includes receiving three-dimensional (3D) data from one or more sensors in a facility, generating a 3D model of the facility based on a first 3D data received from the one or more sensors at a first time, receiving a second 3D data from the one or more sensors at a second time after the first time, determining an event based on the second 3D data and the 3D model, and outputting a notification via an electronic device based on the event.

The method of any of the preceding clauses, wherein the one or more sensors comprise a Light Detection and Ranging (LiDAR) sensor.

The method of any of the preceding clauses, wherein at least one sensor of the one or more sensors is coupled to an unmanned autonomous vehicle (UAV).

The method of any of the preceding clauses, comprising classifying one or more areas of the 3D model, wherein the event is based on the second 3D data and the one or more areas of the 3D model.

The method of any of the preceding clauses, wherein classifying the one or more areas of the 3D model comprises utilizing an artificial intelligence model to implement machine learning.

The method of any of the preceding clauses, wherein the one or more areas are one or more hazardous or restricted areas of the facility, and the event is a human, a vehicle, or an animal entering the one or more areas.

The method of any of the preceding clauses, comprising: actuating a component of the facility based on the event.

A tangible and non-transitory machine readable medium comprising instructions to cause a processing system to receive three-dimensional (3D) data from one or more sensors in a facility, generate a 3D model of the facility based on a first 3D data received from the one or more sensors at a first time, receive a second 3D data from the one or more sensors at a second time after the first time, determine an event based on the second 3D data and the 3D model, and output a notification via an electronic device based on the event.

The medium of any of the preceding clauses, wherein at least one sensor of the one or more sensors is coupled to an unmanned autonomous vehicle (UAV).

The medium of any of the preceding clauses, wherein the one or more sensors comprise a Light Detection and Ranging (LiDAR) sensor.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
one or more sensors configured to obtain three-dimensional (3D) data in a facility; and
a processor communicatively coupled to the one or more sensors, wherein the processor is configured to execute instruction to:
generate a 3D model of the facility based on a first 3D data received from the one or more sensors at a first time;
receive a second 3D data from the one or more sensors at a second time after the first time;
determine an event based on the second 3D data and the 3D model; and
output a notification via an electronic device based on the event.

2. The system of claim 1, comprising an unmanned autonomous vehicle (UAV) having a first sensor of the one or more sensors.

3. The system of claim 2, wherein the one or more sensors comprises a second sensor at a fixed position in the facility.

4. The system of claim 1, wherein the one or more sensors comprise a Light Detection and Ranging (LiDAR) sensor.

5. The system of claim 1, wherein the processor is configured to execute instructions to classify one or more objects or one or more areas within the 3D model.

6. The system of claim 5, wherein the one or more areas are one or more hazardous or restricted areas of the facility, and the event comprises a human entering the one or more hazardous or restricted areas.

7. The system of claim 5, wherein the processor is configured to execute instructions to classify the one or more objects or the one or more areas within the 3D model via an artificial intelligence model, and the artificial intelligence model is configured to implement machine learning to classify the one or more objects or the one or more areas within the 3D model.

8. The system of claim 1, wherein the processor is configured to execute instructions to send an actuation signal to at least one equipment of the facility based on the event.

9. The system of claim 1, wherein the processor is configured to determine the event based on the second 3D data via an artificial intelligence model configured to implement machine learning to determine the event.

10. The system of claim 1, wherein the event comprises a change in position of equipment, a change in an actuator position of the equipment, or a combination thereof, in the facility.

11. A method, comprising:
receiving three-dimensional (3D) data from one or more sensors in a facility;
generating a 3D model of the facility based on a first 3D data received from the one or more sensors at a first time;
receiving a second 3D data from the one or more sensors at a second time after the first time;
determining an event based on the second 3D data and the 3D model; and
outputting a notification via an electronic device based on the event.

12. The method of claim 11, wherein the one or more sensors comprise a Light Detection and Ranging (LiDAR) sensor.

13. The method of claim 11, wherein at least one sensor of the one or more sensors is coupled to an unmanned autonomous vehicle (UAV).

14. The method of claim 11, comprising classifying one or more areas of the 3D model, wherein the event is based on the second 3D data and the one or more areas of the 3D model.

15. The method of claim 14, wherein classifying the one or more areas of the 3D model comprises utilizing an artificial intelligence model to implement machine learning.

16. The method of claim 14, wherein the one or more areas are one or more hazardous or restricted areas of the facility, and the event is a human, a vehicle, or an animal entering the one or more areas.

17. The method of claim 11 comprising:
actuating a component of the facility based on the event.

18. A tangible and non-transitory machine readable medium comprising instructions to cause a processing system to:
receive three-dimensional (3D) data from one or more sensors in a facility;
generate a 3D model of the facility based on a first 3D data received from the one or more sensors at a first time;
receive a second 3D data from the one or more sensors at a second time after the first time;
determine an event based on the second 3D data and the 3D model; and
output a notification via an electronic device based on the event.

19. The medium of claim 18, wherein at least one sensor of the one or more sensors is coupled to an unmanned autonomous vehicle (UAV).

20. The medium of claim 18, wherein the one or more sensors comprise a Light Detection and Ranging (LiDAR) sensor.
